(19) United States
(12) Patent Application Publication
(10) Pub. No.: US 2005/0086830 A1
(43) Pub. Date: Apr. 28, 2005

(54) Processing cap assembly for isolating contents of a container

(76) Inventors: Kenneth S. Zukor, Havre de Grace, MD (US); John L. DiMeo, Wilmington, DE (US); Michael J. Wikol, Landenberg, PA (US)

Correspondence Address: GORE ENTERPRISE HOLDINGS, INC., 551 PAPER MILL ROAD, P. O. BOX 9206, NEWARK, DE, 19714-9206, US

(21) Appl. No.: 10/693,371

(22) Filed: Oct. 24, 2003

(51) Int. Cl. F26B 5/06

(52) U.S. Cl. 34/443; 34/284

(57) ABSTRACT

Improved cap assemblies which isolate materials in containers, e.g., bottles, vials, multi-vial trays, multi-well trays, etc., during processes while permitting vapor to pass into or out of the container, such as during freeze drying and the like, and facilitate subsequent closure of the container to cease such vapor passage (e.g., stoppering, etc.). The cap assembly optimizes containment of solute, prevents contamination, is easy to use and is readily compatible with validated industrial drying processes.

### FIELD OF THE INVENTION

This invention relates to a cap assembly for venting and isolating a container during processes such as freeze-drying, foam-drying, and other forms of evaporative, sublimation, or desorption drying. The cap is designed to isolate the contents of the container, both from contamination and from loss of material, while allowing a path for vapor exchange between the container and an external atmosphere during processing.

### BACKGROUND OF THE INVENTION

Drying techniques are known for the stabilization of a wide variety of foods, pharmaceuticals, and biological products. Evaporative and/or sublimation drying, as used herein, refers to the removal of liquid from a solution and/or the removal of residual moisture and volatiles from a solid to capture the solute in a container for stabilization, ease of storage, transport, or the like, often with the expectation of reconstituting the material in solution for later use. Extreme care must be taken in handling and processing many of these products to minimize opportunities for contamination.

The drying processes used may vary depending on the materials being processed, the desired final form of the materials, processing economics, etc. Typical evaporative or sublimation-based techniques include freeze-drying, foam-drying, vacuum drying, convective drying, dessication, microwave drying, and radio frequency drying, to name several common techniques. Freeze-drying is a widely used drying technique, and, solely for convenience herein, the terms “freeze-drying” and/or “lyophilization” will be used to refer collectively to a range of evaporative and sublimation drying techniques contemplated by one of skill in the art which would benefit from the unique features of the cap assembly of the present invention.

Freeze-drying equipment is often steam-sterilized between batches, and in many cases the entire operating area in which the equipment is located may be outfitted as an aseptic cleanroom to minimize the exposure of products to contaminants as they are being transported to and from the freeze-dryer. In some cases, products must be repackaged after freeze-drying, thus presenting additional handling steps that provide an opportunity to introduce contaminants into the freeze-dried product.

Many freeze-drying processes involve placing open containers of material in the freeze-dryer. Containers are kept open until the freeze-drying process is completed to allow a path for water vapor to be removed from the product. This practice, however, presents an opportunity for contamination; hence the concern for cleanliness and sterility of the freeze-drying equipment and the area surrounding it. Cross-contamination between different batches of product being freeze-dried at the same time is also a problem. Freeze-drying equipment is expensive, and freeze-drying cycles are generally very long, consuming many hours or even several days for the processing of a single batch of material. As a result, it is advantageous for freeze-dryer operators to maximize the use of their capital investment in the equipment by attempting to fully load the freeze-drying chamber every time it is cycled. This in turn can result in the practice of freeze-drying different materials in the same chamber at the same time. Since all of the materials are processed in open containers, cross-contamination of product can, and commonly does, occur.

As noted above, many of the challenges encountered with freeze-drying are common to other forms of evaporative drying; yet other challenges can also exist in these other techniques. For example, in foam-drying processes the volatile nature of the foaming process creates further challenges in product containment due to the sometimes highly effusive nature of the foaming step.

Caps have been developed in the past to address containment; however, limitations with these caps have been identified. For example, in U.S. Pat. No. 3,454,178 to Bender, et al., a vial contains a slotted vial cap that, when in the “open” position, allows a path for water vapor to escape the vial. Vials are introduced into the process with their caps in the “open” position, and remain that way until the drying cycle is complete. At the end of the cycle, freeze-drier shelves squeeze down on the vials and press the caps into the “closed” position, thus sealing the vials before the freeze-drier door is opened. This approach insures that contents of the vials are not contaminated after the process is completed. It also assures that water vapor cannot enter the vials and rehydrate the product once the freeze-drier doors are opened; indeed, the vials are often repressurized at the end of the process with a dry inert gas, such as nitrogen, prior to pushing the vial caps into the “closed” position, to maximize the shelf life of the freeze-dried product. But the problem of contamination of the vial contents when the vials are being loaded into the freeze-drier or during the freeze-dry process itself is not addressed by this patent.

In European Patent No. 343,596, a container that has been designed to protect freeze-dried products from contamination during the freeze-drying process is described. The container has at least one side that includes a hydrophobic, porous, germ-tight, water vapor-permeable membrane. Water vapor can escape the closed container through this porous membrane, while the membrane represents a barrier to contamination. Another technique used, such as that taught in U.S. Pat. No. 5,309,649 to Bergmann, involves freeze-drying material in a container that has a porous hydrophobic wall. Neither of these patents, however, addresses the concern about rehydrating the contents of the container once the doors of the freeze-drier are opened. It is not obvious how products freeze-dried in such a container could be kept dry and finally packaged in a vapor-tight container without first exposing the dried product to humidity. Thus, a need exists for a container for freeze-dried products that maintains a well-defined level of protection throughout the entire drying process, as well as providing means for forming a vapor-tight seal on the container before the freeze-dryer doors are opened.

U.S. Pat. No. 5,552,155, to Jones, teaches a vial cap which incorporates a controllable venting port protected by a venting media. The porous venting media is located in the venting path created between the cap and the vial, and the media provides a barrier to bacteria and other particulate contamination, while permitting the passage of gases such as air and water vapor. However, a challenge with such a vial cap is the risk of puncturing the venting media with a needle when withdrawing the reconstituted solution, raising the concern of contaminating the injectable solution with media fragments. A further challenge with the Jones device is the practical size of the venting media in the vial cap, which can negatively impact the drying time of material in the container.

These and other limitations of the prior art are addressed by the invention described below.

### SUMMARY OF THE INVENTION

This invention relates to a processing cap assembly for isolating materials in a container during evaporative and sublimation drying processes such as freeze-drying and the like. Additionally, other processes where vapor exchange and subsequent closure of such exchange, including cell culturing, fumigation, preservation, mixing or reacting in controlled atmospheres, etc., are within the scope contemplated for this invention. Advantages of the novel cap assembly include, among other things, optimizing containment of solute, preventing contamination (of products, workers, and equipment), ease of use during processing, and compatibility with existing validated primary packaging materials, which minimizes re-validation requirements.

In one preferred embodiment, the processing cap assembly of the present invention includes:
1) a cap having a recess for attaching to a container and forming a seal, preferably a vapor-tight or hermetic seal, and a vapor path opening for vapor passage from the container to an external atmosphere;
2) a venting media attached to the cap and oriented in the vapor path, thereby forming a barrier for isolating against migration of solids and liquids therethrough (i.e., into or out of the container), including bacterial, viral, particulate, and other such material penetration; and
3) means for permitting the vapor path to be opened and closed, whereby the cap assembly is moveable from a first, “open” position to a second, “closed” position.

The novel cap assembly of the invention is adaptable to any number of containers suitable for freeze-drying operations. For example, depending on the desired container, the cap assembly may be configured to isolate materials in individual containers or multi-unit or container systems, ranging from bottles or vials (e.g., any closable vessel) to multi-vial trays or even multi-well trays, etc. In addition, the cap assembly of the invention may be adapted to hold one or more stoppers within the assembly prior to the freeze-drying operation, or alternatively, the cap assembly may simply be placed over the stopper or stoppers during processing. The cap assembly may further be adapted so that some portion or all of the cap assembly remains with the stoppered vial and may assist in protecting the stoppered vial during transport and storage, or alternatively, the cap assembly may be completely removed from the stoppered vial after the freeze-drying processing is completed.

An exemplary process for using the cap assembly of the present invention includes, but is not limited to:
(a) filling the container with product under sterile conditions;
(b) sealing the cap assembly of the present invention, with or without a stopper attached thereto, and positioning the stopper over or onto the mouth of the container with the cap assembly in the “open” position to provide a vapor path out of the container;
(c) drying the product in the container under appropriate freeze-drying or other drying conditions, allowing the vapor to escape through the venting media via the vapor path;
(d) sealing or “closing” the vapor path by pressing down on the stopper; and
(e) optionally, either leaving the cap assembly with the stoppered vial or removing the cap assembly from the stoppered vial.

These and other features of the present invention will be described in more detail based on the drawings and examples provided herein.

### BRIEF DESCRIPTION OF THE DRAWINGS

FIG. 1 shows a cross-sectional perspective view of a cap assembly of the present invention depicting the internal geometry of the assembly.

FIG. 2 shows a top perspective view of the processing cap assembly of FIG. 1.

FIG. 3 shows the processing cap assembly of FIG. 1 positioned over a vial in the open position, with the vapor path for drying contents of the vial depicted by the dotted arrow.

FIG. 4 shows the processing cap assembly and vial shown in FIG. 3 with the cap assembly in the closed position.

FIG. 5 depicts the cap assembly of FIG. 1 with the cap assembly removed from the vial and the stopper remaining in the vial.

FIG. 6 is a cross-sectional perspective view of an alternative cap assembly of the present invention depicting the internal geometry of the assembly.

FIG. 7 is a cross-sectional perspective view of a further alternative cap assembly of the present invention

FIG. 8 is a cross-sectional perspective view of another alternative cap assembly of the present invention.

FIG. 9 is a cross-sectional perspective view of another alternative cap assembly of the present invention.

FIG. 10 is a cross-sectional perspective view of a further alternative cap assembly of the present invention.

FIG. 11 is a cross-sectional perspective view of another alternative cap assembly of the present invention.

FIG. 12 is a cross-sectional perspective view of a further embodiment of a cap assembly of the present invention.

FIG. 13 is a cross-sectional perspective view of the cap assembly of FIG. 12 incorporating a lyophilization stopper, the assembly positioned in the vial in the open position, with the vapor path for drying contents of the vial depicted by a dotted line.

FIG. 14 shows the processing cap assembly of FIG. 13 with the cap assembly and stopper positioned to close off the vapor path out of the vial.

FIG. 15 depicts the cap assembly of FIGS. 13-14 with the cap assembly removed from the vial and the stopper remaining in the vial.

FIG. 16 is a partial cross-sectional perspective view depicting an alternative cap assembly of the present invention wherein the cap assembly is adapted to attach to a tray containing multiple vials, where the vapor path for drying contents of the vials is depicted by the arrow.

FIG. 17 is a partial cross-sectional perspective view depicting the assembly of FIG. 16 with the cap assembly in the closed position and the stoppers seated in the vials.

FIG. 18 is a cross-sectional perspective view of a further embodiment of a cap assembly of the present invention incorporating a stopper, wherein the assembly is positioned on a vial in the open position, with the vapor path for drying contents of the vial depicted by a dotted line.

FIG. 19 shows the processing cap assembly of FIG. 18 with the cap assembly and stopper positioned to close off the vapor path out of the vial.

FIG. 20 depicts the cap assembly of FIGS. 18-19 with a portion of the cap assembly of this embodiment crimped around the neck of the vial and a portion removed.

FIG. 21 is a cross-sectional perspective view of an alternative embodiment of the present invention, wherein the container over which the cap assembly is oriented comprises a multi-well plate and the stopper comprises a multi-stopper pad, the cap assembly being positioned over the container in the open position with the vapor path depicted by the arrow.

FIG. 22 is a partial cross-sectional perspective view depicting the assembly of FIG. 21 with the cap assembly in the closed position and the multi-stopper pad sealed in the multi-well container.

FIGS. 23A-C depict one removal system for removing the cap assemblies of the present invention.

### DETAILED DESCRIPTION OF THE INVENTION

The present invention relates to improved cap assemblies which isolate materials in containers, e.g., bottles, vials, multi-vial trays, multi-well trays, etc., during processes while permitting vapor to pass into or out of the container, such as during freeze-drying and the like, and facilitate subsequent closure of the container to cease such vapor passage (e.g., stoppering, etc.).

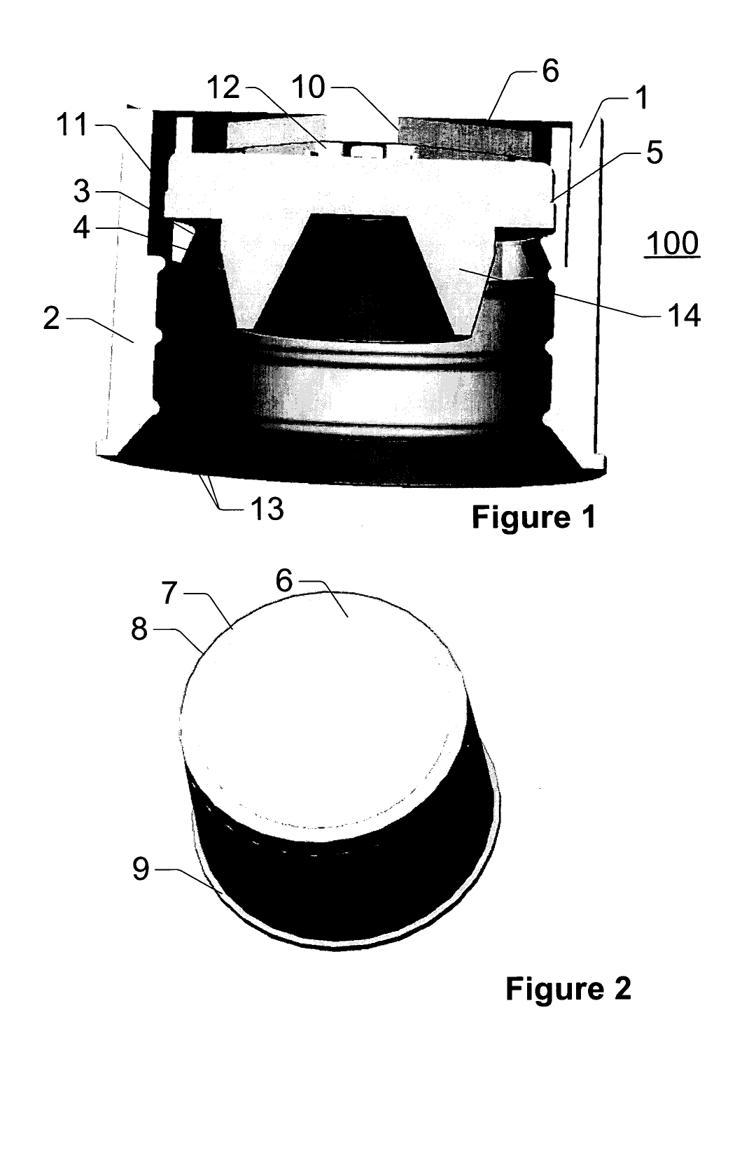

Referring to FIGS. 1 and 2, there is shown one embodiment of a cap assembly 100 incorporating a stopper 14. In this embodiment, which is a preferred construction, the cap assembly 100 comprises a two-component part including a rigid housing section 1 and a conformable (e.g., capable of conforming around a portion of the container to form a seal therewith, such as an elastomeric material) section 2. The cap assembly 100 has internal geometries as shown for holding the stopper 14 and mating with, for example, the head and neck regions of a vial (not shown). The elastomeric section 2 has an internal recess with a geometry adapted for mating with a vial to be sealed. Specifically, ribs 13 are provided to assist in sealing the assembly 100 to the vial. Dimple 3 in the rigid housing section 1 holds the stopper 14 in place adjacent to the recess prior to insertion of the stopper into a vial. Slated face 4 functions during transfer of the stopper to the vial by engaging the vial neck and expanding the rigid housing section 1 so that the dimple 3 releases the stopper 14 for insertion into the vial. Face 5 on the interior of the rigid housing 1 maintains the stopper 14 centered within the housing 1. Venting media 6 is centered within lip 8 and attached to the housing 1 by a seal 7 around the perimeter of the housing 1. Crossbars 10 with projecting surfaces 12 support the venting media 6, as well as providing a surface against which the stopper 14 is secured within the housing 1. Venting slots 11 provide a vapor flow path around the stopper 14. Projection 9 facilitates orientation of the cap assembly during processing using automated equipment.

Suitable materials for this two-part cap assembly include rigid materials such as some plastics, some thermosets, metals, or the like, and conformable materials such as elastomers, plastics, rubbers, some thermosets, thermoplastics, or the like. A particularly preferred combination of materials is an injection molded polypropylene rigid section such as Profax 6523, and a thermoplastic rubber, such as Santoprene® 281-45 thermoplastic rubber, conformable section. An advantage to using such a two-part construction is that each material functions to allow the cap to operate more effectively. For example, the rigid plastic material provides stiffness to the cap to facilitate sealing the venting media to the cap assembly and handling of the cap assembly during use, while the conformable component facilitates sealing of the cap assembly to the vial.

In a preferred method of forming such a two-component cap assembly, the two components are bonded together via conventional molding techniques. A mold generally consisting of two halves, a stationary side, or A side, and a moveable side, or B side, that can be used to mold the part. The cap's rigid housing component is formed of a plastic material. The B side of the tool rotates to create a cavity for the elastomeric component (e.g., a thermoplastic rubber) to be injected. In the liquid or melted state, the thermoplastic comes in contact with the plastic material and creates a bond between the two components to join them into a single part. Such a bonded single part construction provides the benefit that no interface exists between separate components where dirt, particles, or other contaminates could become entrapped which would make the part more difficult to sterilize.

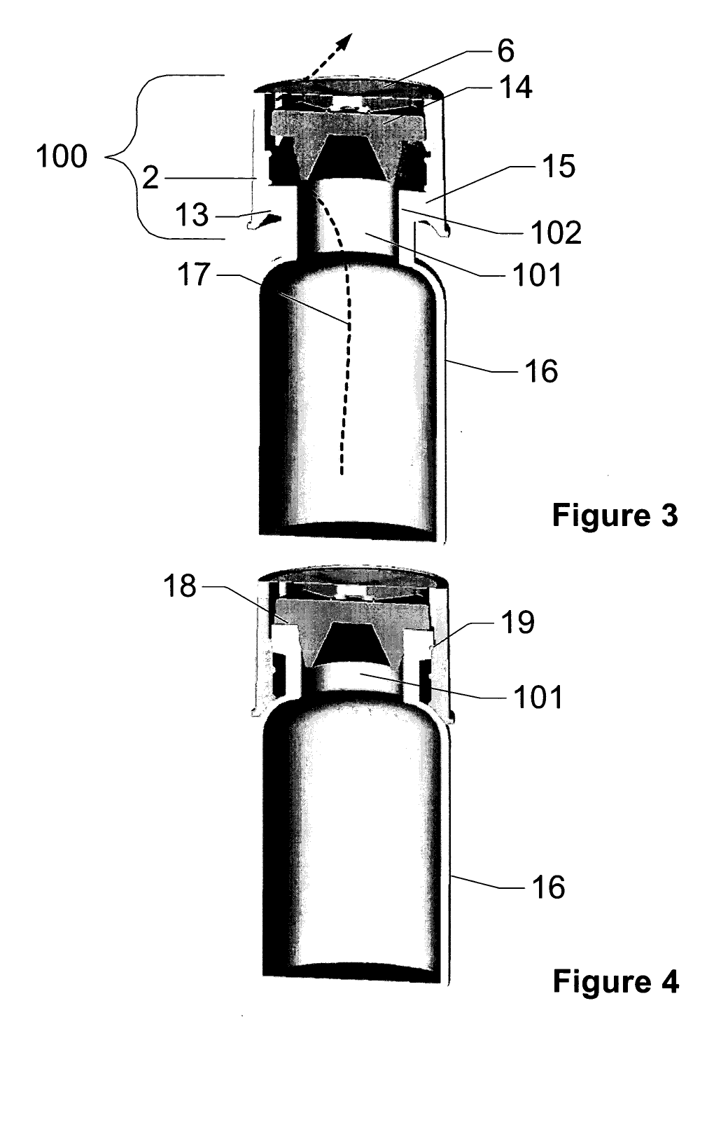

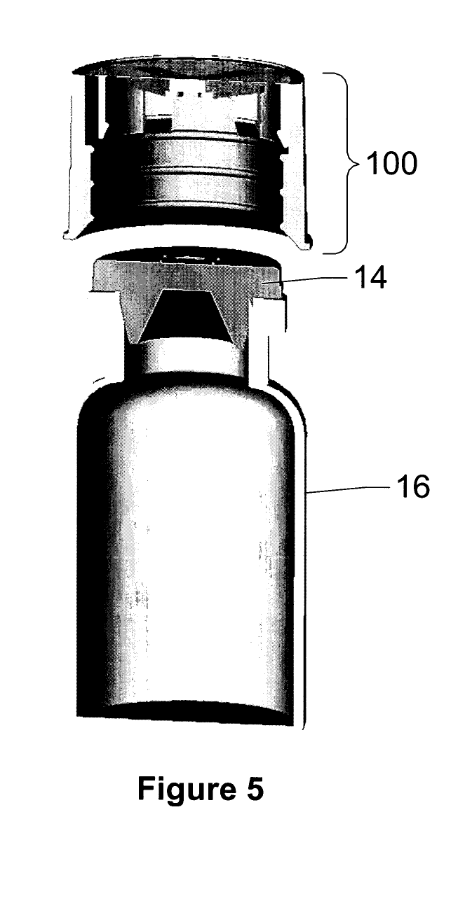

FIG. 3 shows the cap assembly 100 of FIG. 1 positioned over a vial 16, in what can be referred to as the “open” position, with the vapor path for drying contents of the vial depicted by the dotted arrow 17. The rib(s) 13 in the elastomeric section 2 of the cap assembly 100 seal the cap assembly against the head 102 of the vial 16 to assist in creating a seal at surface 15, while the stopper 14 is positioned over, but not in, the throat 101 of the vial 16. Drying of contents in the vial occurs via the vapor path 17, around stopper 14 and out through the venting media 6. FIG. 4 shows the cap assembly 100 of FIG. 3 in the “closed” position, with the vapor path sealed off by the stopper 14 which is positioned in the throat 101 of the vial 16 and seals the vial at sealing surface 18. Additionally, the cap assembly 100 is sealed to the vial at sealing surface 19. FIG. 5 depicts the cap assembly of FIG. 4 with the cap assembly 100 removed from the vial 16 and the stopper 14 remaining sealed in the vial 16.

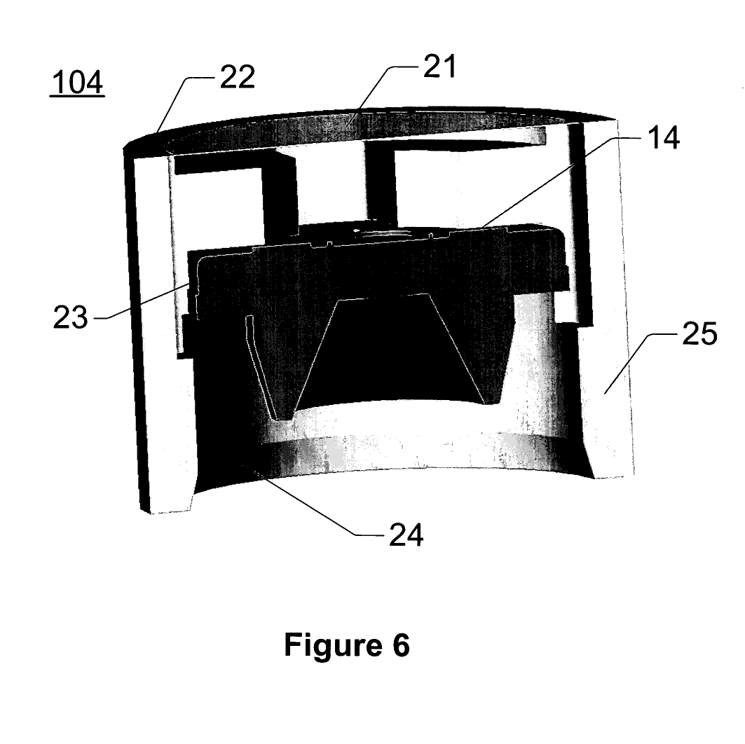

In an alternative construction of the cap assembly of the present invention, the cap assembly may comprise a single material, such as is depicted in FIG. 6. Cap assembly 104 is formed from a single material 25, such as a plastic rod having sufficient rigidity for attaching the venting media, yet some degree of conformability for attaching to the vial. The plastic is machined to achieve the geometry shown. The cap assembly holds stopper 14 within the assembly by a surface friction fit along surface 23. Internal surface 24 is a sealing surface for sealing the cap assembly to a vial (not shown). Venting media 21 is attached to the cap assembly 104 at the sealing perimeter 22 by any suitable attachment means, such as heat sealing, impulse welding, ultrasonic welding, RF welding, adhesives, solvent bonding, or the like.

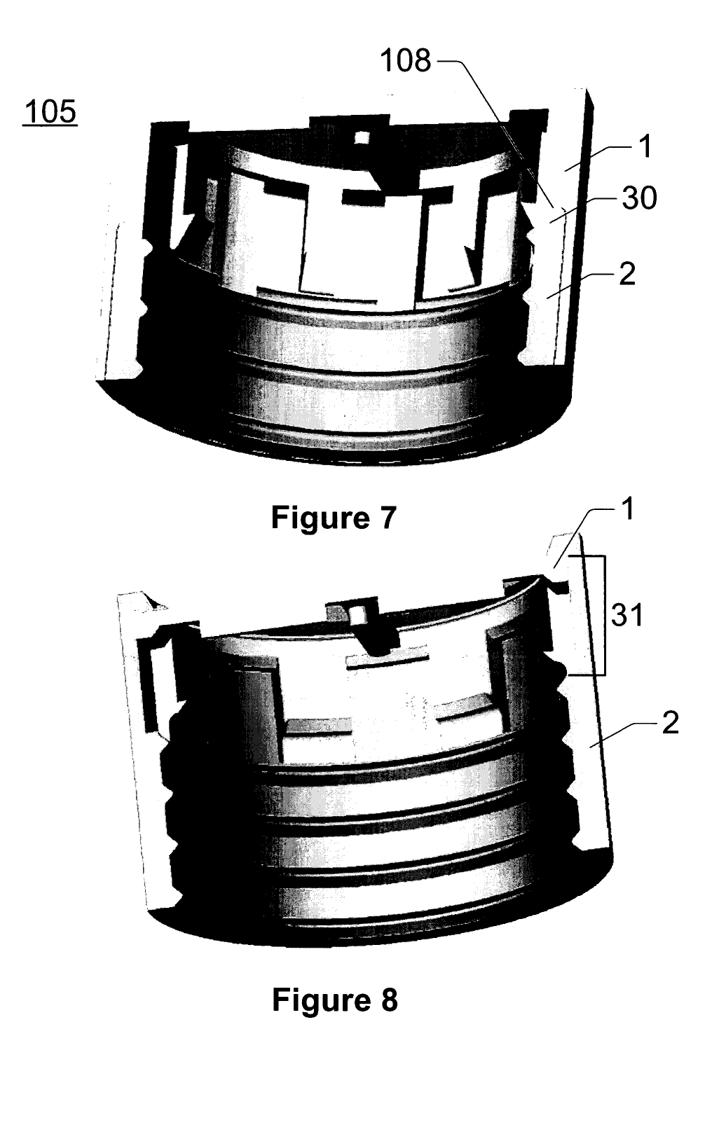

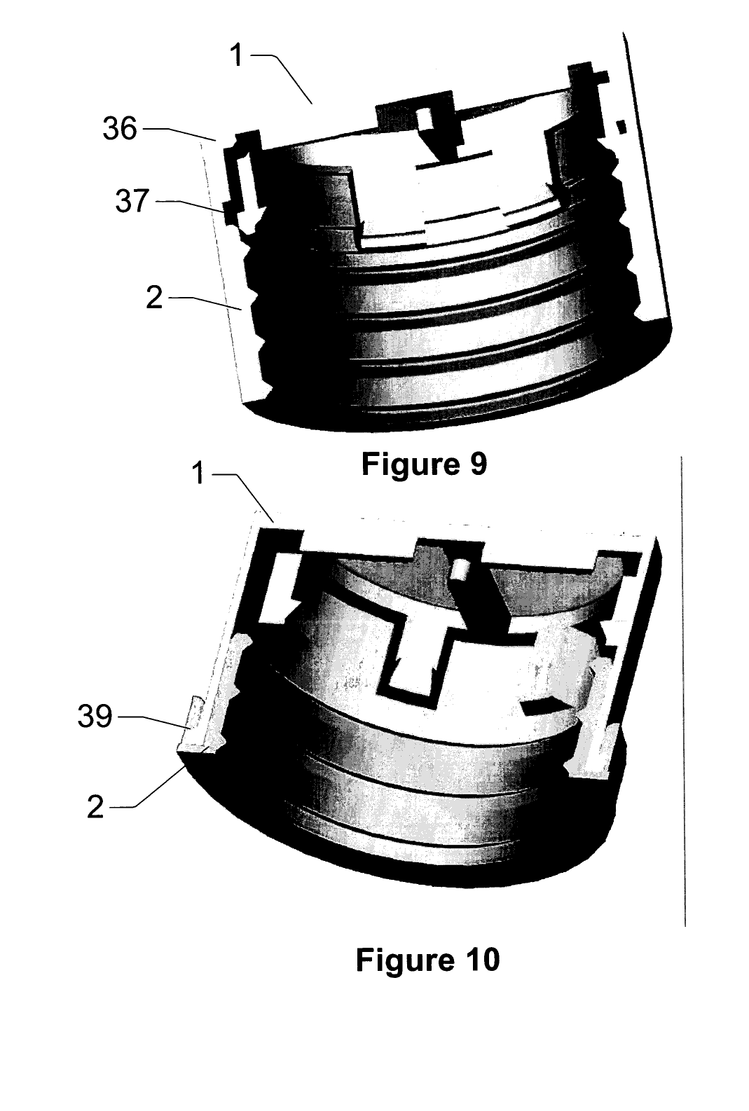

Other two-part cap assemblies are also contemplated in the present invention. For example, rather than molding the two dissimilar parts together into the cap assembly as described above, the two parts may be configured to snap, twist, or otherwise lock together without creating a bond. FIGS. 7-10 depict cap assemblies with various geometries for joining the two components together. For example, in the embodiment of FIG. 7, the cap assembly 105 comprises a rigid housing section 1 with recess 108 and an elastomeric section 2 having a snap ring 30 which fits into recess 108. Alternatively, FIG. 8 shows an embodiment wherein the rigid housing section 1 is inserted into a recess or groove 31 of the elastomeric section 2. FIG. 9 shows a further alternative embodiment of a cap assembly wherein a recess 37 in the elastomeric section 2 is configured so that the rigid housing section 1 can lock into the elastomeric section and the two components are sealed along sealing surface 36. Alternatively, FIG. 10 depicts an embodiment of a so-called “snap-ring” two-part construction, wherein the rigid housing section 1 “snaps” into the recess 39 of the elastomeric section 2.

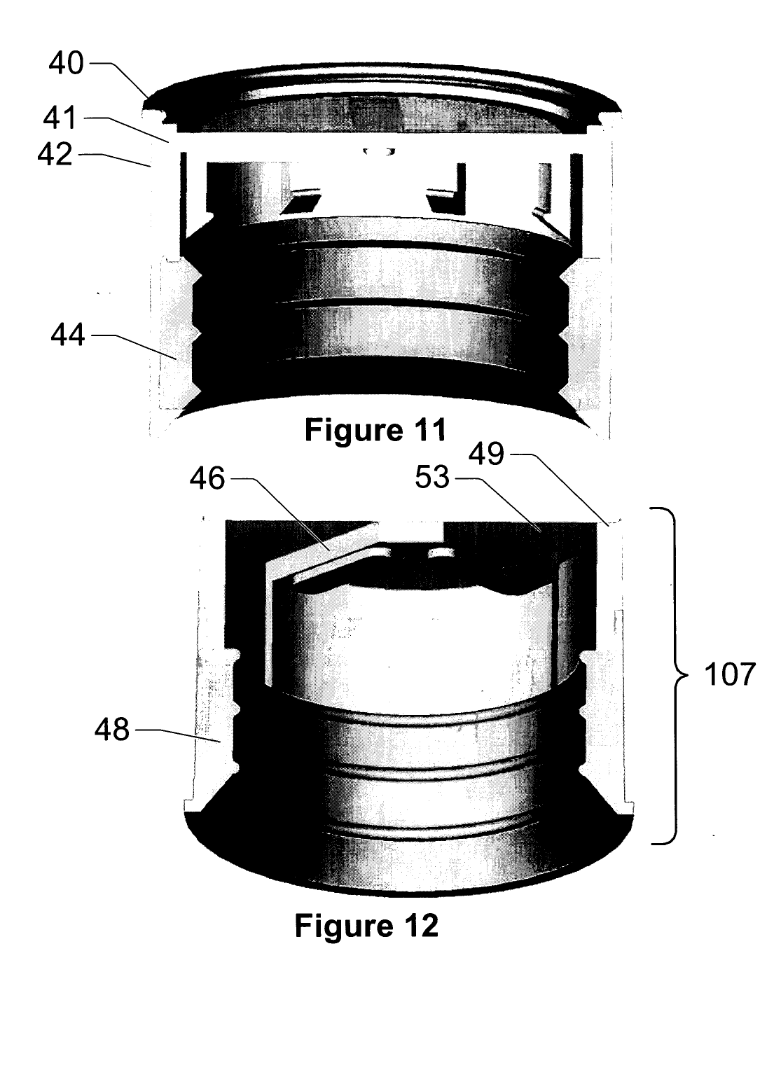

It is further contemplated that more than two components could be joined (e.g., locked, bonded, etc.) together to form the cap assembly of the present invention, as shown in the embodiment of FIG. 11. Specifically, an outer rigid housing 42 could be fitted with an elastomeric component 44 and an inner rigid housing component 41 snap fitted with sections 42 and 44 and held by dimple 40 to provide the cap assembly of this embodiment. It would be apparent to an artisan of skill in the art that many alternative multi-part configurations would be suitable and contemplated within the scope of the cap assembly of the present invention.

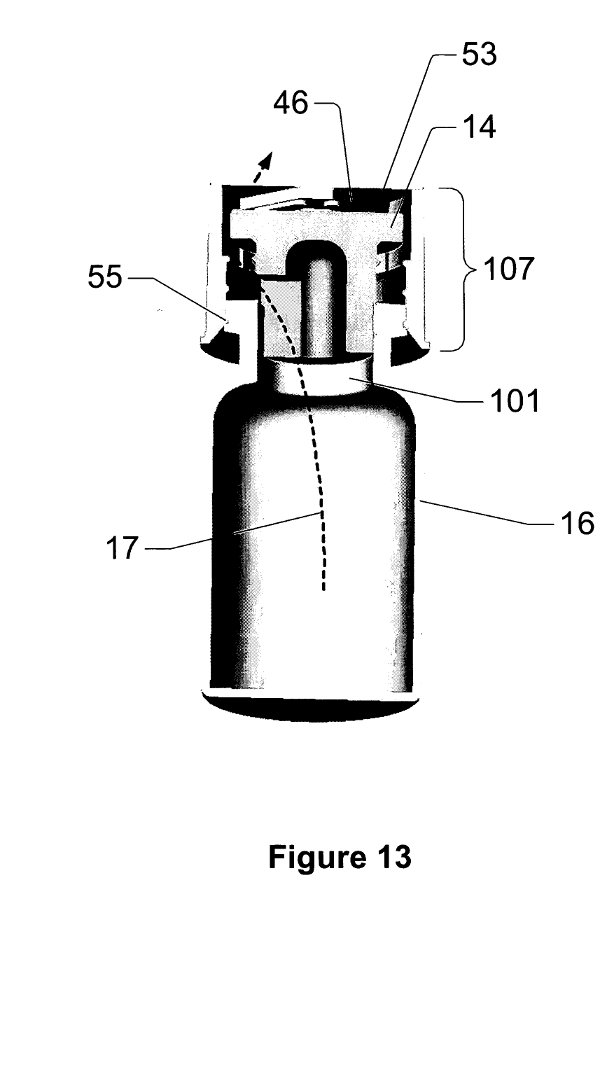

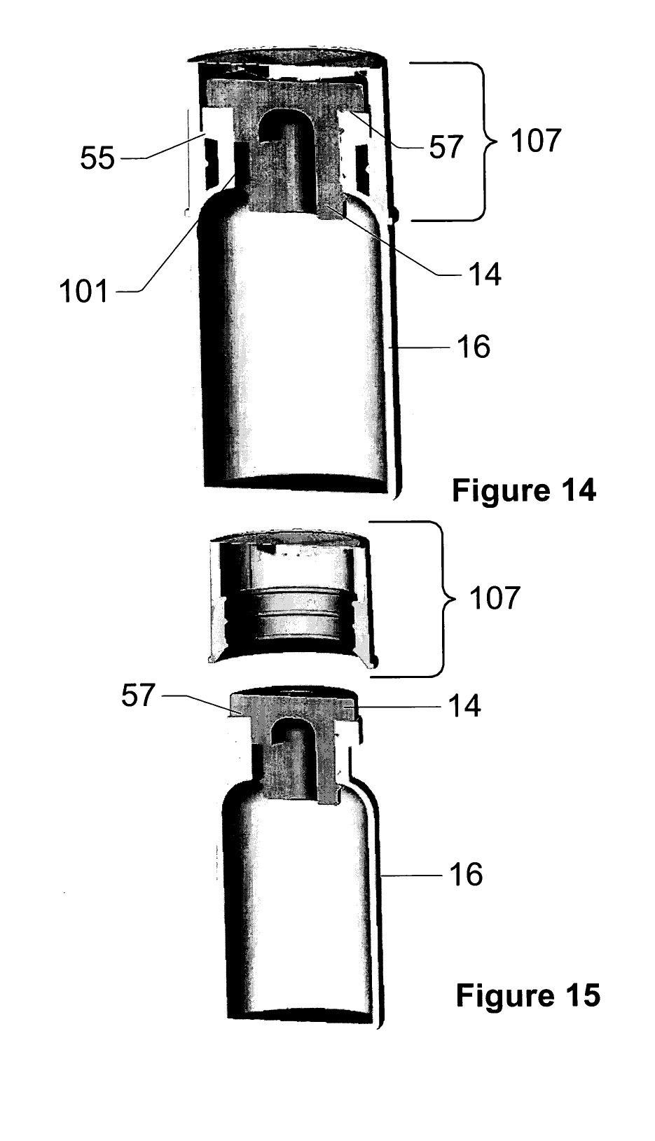

FIGS. 12-15 depict a further embodiment of the cap assembly of the present invention, wherein the cap assembly is adapted so that it can cover a stopper during processing, but the cap does not contain a dimple or other similar geometry for holding the stopper in the cap assembly. In the figures, a lyophilization stopper is depicted for the stopper rather than the serum stopper shown in the earlier figures. It should be appreciated by one of skill in the art that any suitable stopper which functions to seal a vial or container is contemplated to be suitable for use with the novel cap assembly of the present invention. For example, it is a current practice in the freeze-drying industry to use what are referred to as lyophilization stoppers such as those sold by the West Company, with a geometry substantially as shown. These stoppers have one or more slots or channels which create a vent path from the vial to the external atmosphere. Referring to FIG. 12, there is shown a cap assembly 107 comprising an elastomeric component 48 and rigid component 49 with cross-bars 46 for supporting the venting media 53. In FIG. 13, the cap assembly 107 covers, but does not hold, the stopper 14 which is positioned in the throat 101 of the vial 16. Dotted arrow 17 depicts the vapor path in this instance where the stopper 14 and cap assembly 107 are in the “open” position for drying contents of the vial. A seal is created at the sealing surface 55 between the cap assembly 107 and the vial 16, as shown. FIG. 14 shows the cap assembly 107 of FIG. 13 in the “closed” position, with the vapor path sealed off by the stopper 14 which is positioned in the throat 101 of the vial 16 and seals the vial at sealing surface 57. Additionally, the cap assembly 107 is sealed to the vial at sealing surface 55. FIG. 15 depicts the cap assembly of FIG. 14 with the cap assembly 107 removed from the vial 16, and the stopper 14 remains sealed in the vial 16 at sealing surface 57.

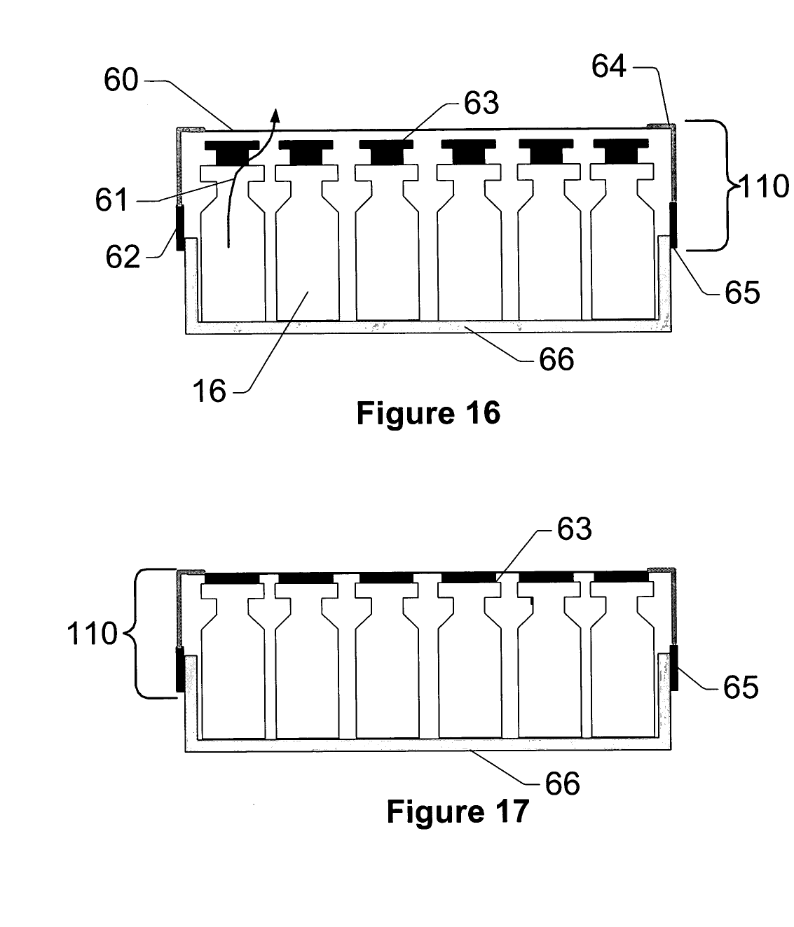

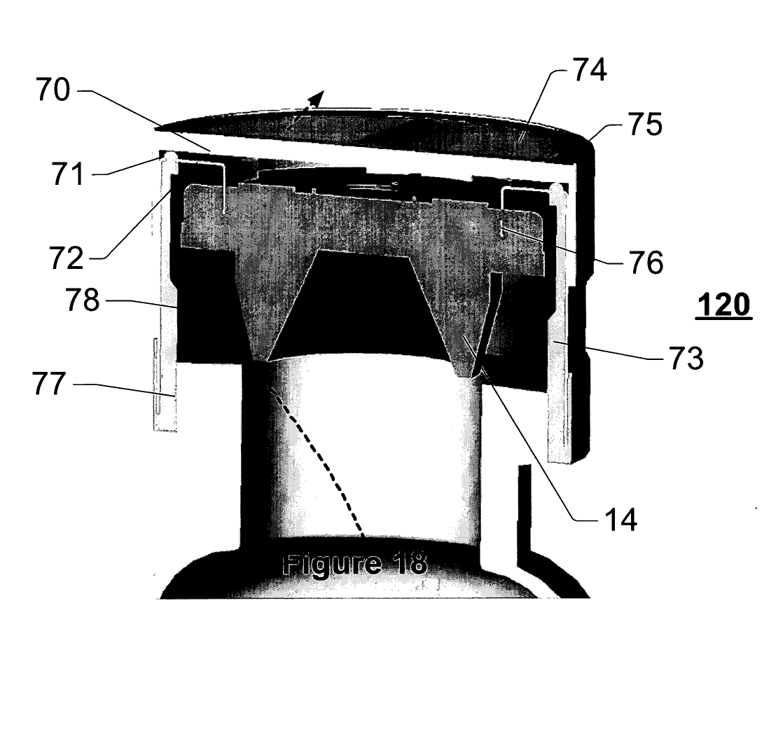

FIG. 16 shows an alternative configuration of a cap assembly of the present invention, wherein the cap assembly seals at sealing surface 65 to a container such as tray 66, which could be a conventional metal tray used in lyophilization or some other appropriate tray, capable of holding one or more vials for freeze-drying of the contents. Specifically, cap assembly 110 includes a rigid housing 64, an elastomeric section 62 and a venting media 60 attached to the cap assembly 110 with the geometry shown for attaching to the tray 66. The lyophilization stoppers 63 in the individual vials 16 are oriented in the “open” position to permit vapor path 61 to flow from the vials and through the venting media 60 to dry the contents of the vials during processing. FIG. 17 shows the set-up of FIG. 16 in a “closed” position, wherein an appropriate force has moved the stoppers 63 into the vials to form a seal in the vials, and a seal is maintained between the cap assembly 110 and the tray 66 at sealing surface 65. One example of a suitable force or means for moving the cap assembly onto the tray and the stoppers into the vials to achieve the “closed” position is the collapsing shelving mechanism which is currently used in conventional freeze-drying units; however, other means would also be apparent to one of skill in the art.

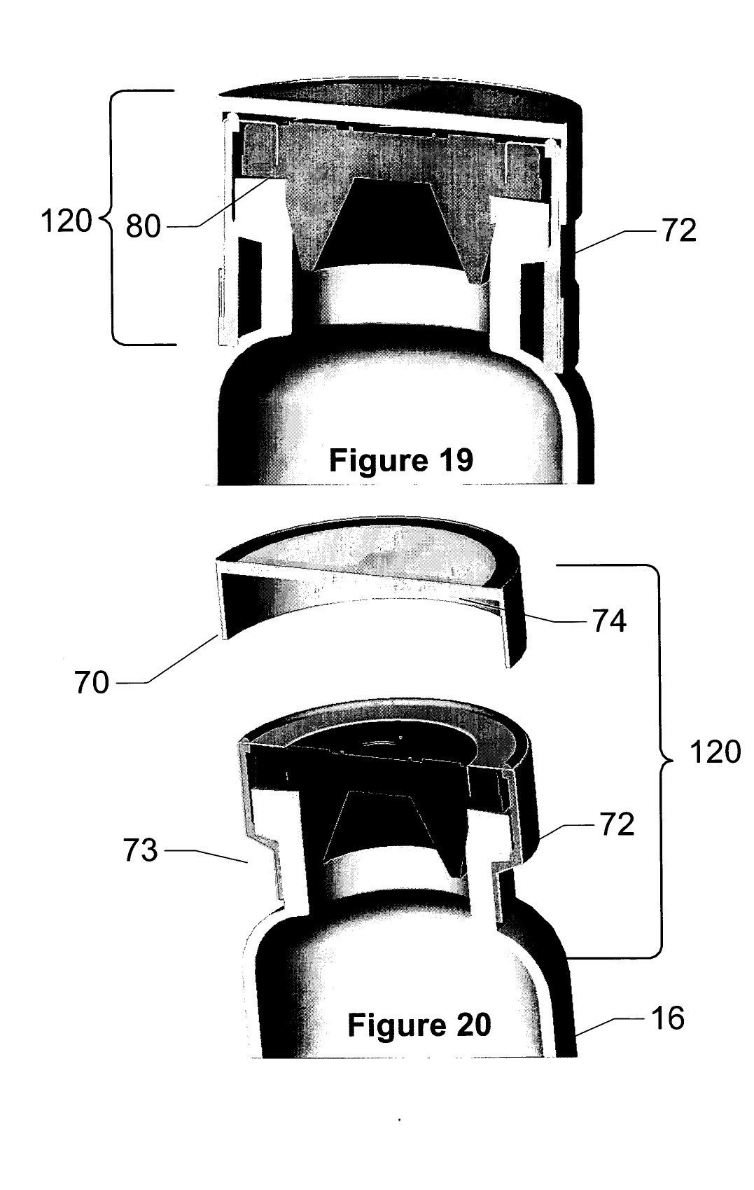

FIGS. 18-20 depict an alternative construction of a cap assembly 120 of the invention, this embodiment incorporating a metal component 72 adapted to be crimped to the stoppered vial after processing of the materials in the vial. Referring to FIG. 18, there is shown a cap assembly 100 comprising a rigid component 70 of an injection-molded thermoplastic conformable component 73, metal component 72, and venting media 74 attached to the rigid component 70 at bonding perimeter 75. Metal component 72 extends into rigid component 70 and a seal 71 is created therebetween. FIG. 18 also shows the cap assembly 120 oriented and sealed at sealing surface 77 over vial 16 with stopper 14 oriented in the “open” position to allow vapor passage out of the vial 16 and through cap assembly 120 via the vapor path indicated by dotted line 78. The metal component 72 cuts or extends into and holds stopper 14 at lip, or extension 76 so that the stopper 14 is held in the open position over the vial 16. FIG. 19 shows the cap assembly 120 on the vial 16 in the “closed” position with the stopper 14 sealing the vial at sealing surface 80 and maintained within the vial by the metal component 72. FIG. 20 depicts the cap assembly 120 with the metal component 72 and conformable component 73 crimped over the stoppered (now in the closed position) vial 16, with rigid component 70 separated from the crimped portion. One benefit to such a construction is that a secure means is provided for retaining the stoppered vial (i.e., crimping), while the venting media 74 attached to the rigid component 70 can be removed and there is no concern to the end user that a needle inserted into the stopper would need to pierce the venting media during use and thus raise concerns about contamination.

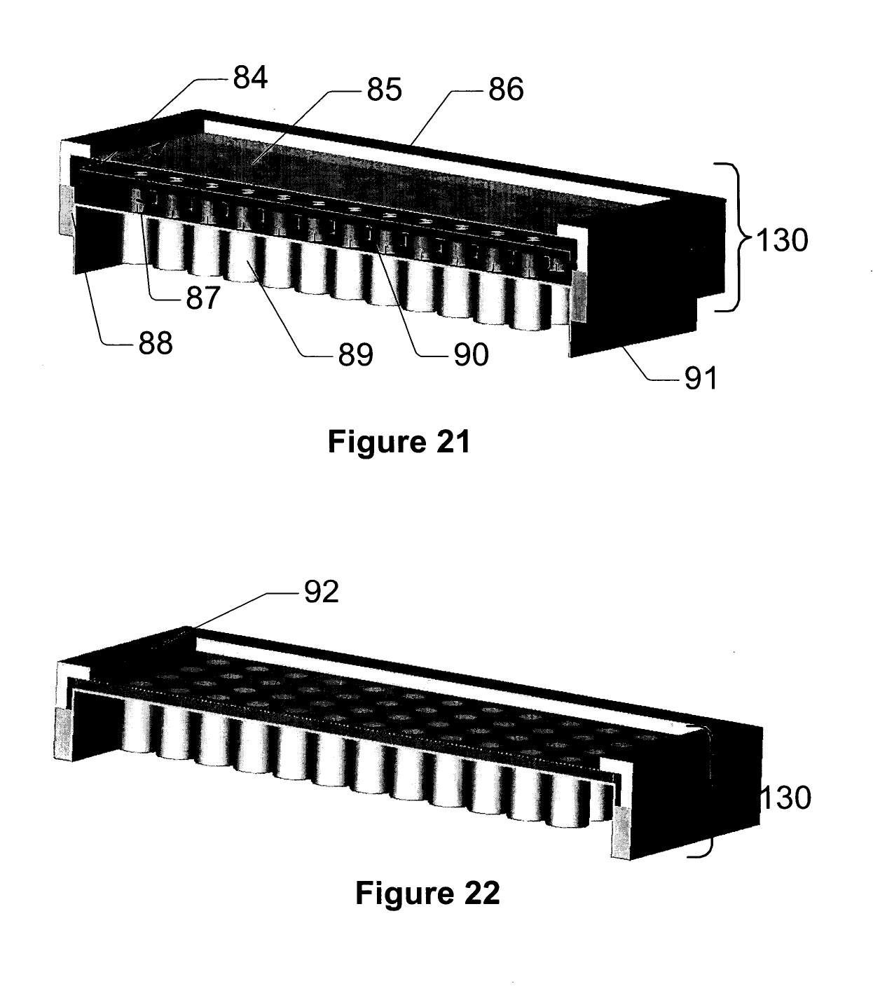

Referring to FIG. 21, there is shown a cross-sectional perspective view of a multi-well container assembly oriented in an open configuration to permit vapor passage, wherein the cap assembly 130 comprises rigid component 86, with venting media 85 attached to the rigid component 86, and conformable component 91 sealed to the multi-well container 89 at sealing surface 88. Multi-plug stopper 90 is oriented and held in the open position over the multi-well container 89. The vent path is depicted by dotted arrow 84, with the path exiting the well through vented stopper pad 87. FIG. 22 shows the set-up of FIG. 21 in a “closed” position, wherein an appropriate force has moved the multi-plug stopper 90 into the wells of the multi-well container 89 to form a seal in the vials, and a seal is created between the cap assembly 130 and the multi-well container 89 at sealing surface 92.

Suitable materials for the venting media include any material that is vapor-permeable, but which provides an effective barrier for isolating against migration of solids and liquids therethrough, including bacterial, viral, particulate, and other such material penetration. Examples of venting media include, but are not limited to, papers, non-woven polymer films such as polyolefins, and porous polymer membranes such as expanded porous PTFE (ePTFE), and combinations thereof. It is preferred that the venting media be hydrophobic. By hydrophobic it is meant that the media is resistant to penetration by water. Preferably, the materials' resistance to water vapor flow versus effective pore size should also be considered. Nominal pore sizes in the 0.1 to 3.0 micrometer range have been demonstrated to yield performance in bacterial challenge tests that are generally associated with venting media, and larger pore sizes may be appropriate under certain circumstances. The smaller the pore size, the more reliable the barrier performance. For the aforesaid ePTFE, which has a microstructure of nodes interconnected with fibrils, nominal pore sizes of 0.1 micrometer up to 3.0 or more micrometers are useful. Conversely, smaller reference pore sizes in a given material will also yield higher resistance to vapor flow, which can affect productivity of drying processes. Expanded PTFE is a preferred venting media based on its superior combination of hydrophobicity and water vapor flow for a given nominal pore size, as well as its chemical inertness.

While the venting media is shown to be located on top of the cap assembly, it is also contemplated to be located in other positions, provided it is still within the vapor path.

The venting media may be attached to the housing of the cap assembly, whether the assembly is a one-part or multi-part construction, by any suitable attachment means which provides a seal between the media and the housing. For example, the media may be attached by heat sealing, impulse welding, ultrasonic welding, RF welding, adhesives, solvent bonding, or the like.

As indicated in the description relating to the figures, there are a wide variety of configurations of vapor path openings, venting media, stoppers or other plugs, and cap assemblies that may be contemplated which would remain within the scope and spirit of this invention. Likewise, there are a variety of suitable materials that may be appropriately used in connection with this invention.

An exemplary process for using the cap assembly of the present invention includes, but is not limited to:
(a) filling the container with product under sterile conditions;
(b) sealing the processing cap assembly of the present invention, with or without a stopper attached thereto, and positioning the stopper over or onto the mouth of the container with the cap assembly in the “open” position to provide a vapor path out of the container;
(c) drying the product in the container under appropriate freeze-drying or other drying conditions, allowing the vapor to escape through the venting media via the vapor path;
(d) sealing the vapor path by moving the stopper to a closed position; and
(e) optionally, either leaving the cap assembly with the stoppered vial or removing the cap assembly from the stoppered vial.

In addition, other processing steps which may be unique to a particular drying technique may create a need for further steps; however, such additional steps will not detract from and would be encompassed within the scope of the invention.

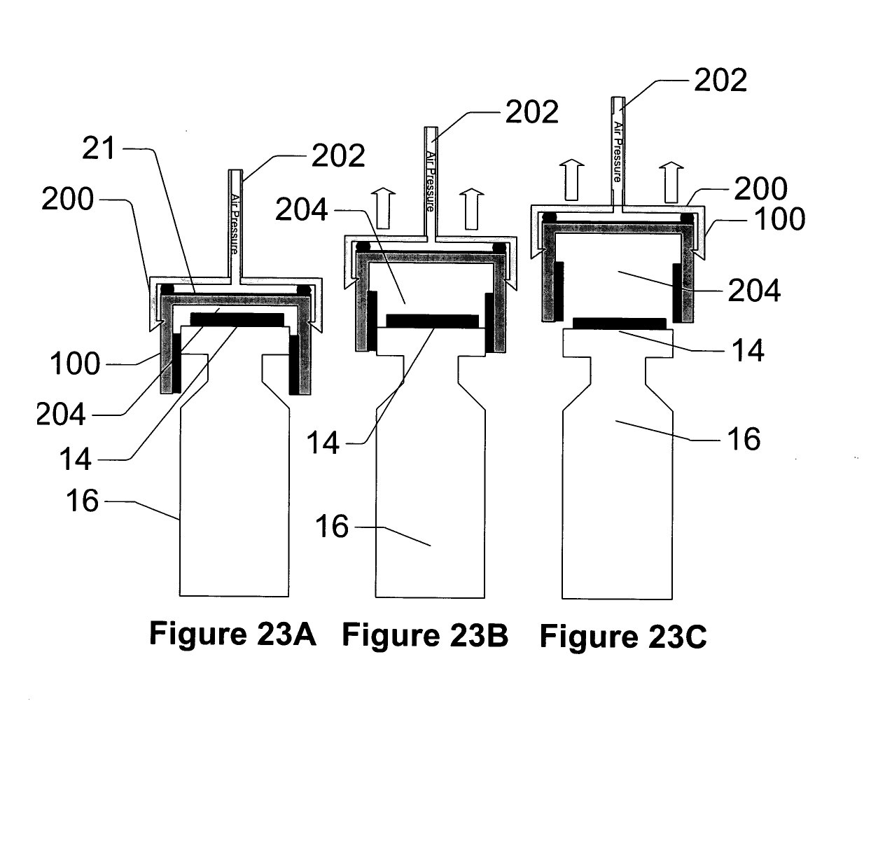

Removal of the cap assembly from the sealed vial/stopper unit is sometimes desirable, depending on the requirements of the freeze-drying processor and/or the end user. One suitable technique for removing a cap assembly of the present invention involves the use of air pressure to lift the cap assembly off of the vial, while leaving the stopper sealed in the vial. FIGS. 23A-C depict the steps in this air pressure removal technique. Specifically, referring to FIG. 23A, a grip 200 moves onto the cap assembly 100 and creates a seal around the venting media 21. Air pressure is then applied against the cap assembly 100 through conduit 202. Air passes through the venting media and pressurizes the volume 204 inside the cap assembly 100, and the air pressure increases the volume 204 by forcing the combined stopper 14 and vial 16 out of the cap assembly 100 (see FIG. 23B) until the cap assembly 100 is completely separated from the vial and stopper (see FIG. 23C), and the air pressure is released. This air pressure removal technique allows for easy removal of the cap assembly, while ensuring that the stopper remains sealed in the vial. Alternatively, it is contemplated that any suitable gripping mechanism or device may be used which can grip the cap assembly and remove it from the vial without disturbing the stopper sealed in the vial.

It will be apparent to one of skill in the art that any suitable technique for removing the cap assembly may be used, or alternatively, the cap assembly may be maintained with the vial and stopper during shipping and storage until the contents of the vial are to be used by the end user.

Embodiments of the present invention will now be described by way of example only with reference to the following examples.

### Test Methods

Cake Appearance and Solubility Test

For the Cake Appearance and Solubility Test, a vial containing a lactose solution was covered with a cap assembly of the invention and lyophilized. All cap assemblies contained a 20 mm serum stopper (West Pharmaceuticals, part number 19500080). The resulting dried cake (the lyophilized product that remains in the vial after the cycle is complete) in the vial was evaluated for appearance and solubility. Ideally, the lyophilized product obtained with the cap assembly of the invention should not differ from the same product obtained using a standard lyophilization stopper. Should the cap assembly not provide sufficient venting, the cake will suffer ‘meltback’. Meltback is a term used to describe what occurs when the cake is not completely dried and the liquid melts and reconstitutes some of the product. This is easily visible to the naked eye. Meltback is not just a visual appearance problem, as cakes which meltback can pose problems including high residual moisture content, decreased solubility (increased or infinite dissolution time), decreased stability (shelf life), etc.

To evaluate the cap assemblies, a 3% lactose solution was lyophilized. This solution was prepared by adding 30 grams of D-(+)-Lactose Monohydrate Powder (Part number 2248-01, CAS No 64044-51-5 from J. T. Baker) to 970 mL of water. The solution was mixed using a magnetic stir plate for at least one hour.

During all lyophilization experiments, controls were included during each run. These controls used a standard lyophilization stopper (West Pharmaceuticals, part number 19500240) in place of a cap and stopper assembly.

All testing was performed on a lab-scale lyophilizer supplied by FTS Systems, model “Dura-Stop μP”. Lyophilization parameters follow. The shelves were not pre-cooled. Freezing temperature was −50° C., cooled down from ambient temperature at a rate of 2.5° C./min. Vials were held at the freezing temperature for six hours. After the six hour hold was complete, the pressure of the lyophilizer was decreased to 50 millitorr and remained at that level until primary drying was completed. The primary drying cycle occurred while the contents of the vial were heated from the freezing temperature to −10° C. at a rate of 2.5° C./min. Secondary drying did not begin until all of the vials completed primary drying. Secondary drying occurred while the contents of the vial were heated to 25° C. at a rate of 2.5° C./min. Vials were not removed from the lyophilizer until all of them reached a temperature of 25° C. Upon removal, cakes of all of the experimental vials were compared to cakes obtained using standard lyophilization stoppers.

Cake appearance and solubility were the two characteristics that were evaluated. Cakes were visually examined and compared to that of the control cakes obtained during that experminent. Cakes were graded on a system of 1 (best) to 4 (worst) with 1 meaning that the cake was identical (visually) to the control cake. Solubility was determined by adding water to the vial and observing how long it took for the cake to go into solution. All control cakes went into solution instantly and any test cakes that did not do so were categorized as failures.

Virus Filtration Efficiency (VFE) Test

While it is undesirable in the freeze-drying process, it is possible that liquid might form on the venting medium or in the vial and small droplets might be entrained by the evolving vapors. Contamination could be carried in these droplets out through the vent port. Similarly, airborne contaminants from people, equipment, or the environment could travel into an open or partially sealed container. The Virus Filtration Efficiency Test is used to determine whether the barrier material of the cap assembly provides a barrier to aerosolized contaminants.

A solution is prepared by inoculating a nutrient broth with Esherichia coli (ATCC #13706) and allowing it to grow to a density of 2-4×10⁸ colony forming units (CFU). This solution is then inoculated with a ΦX174 bacteriophage stock culture (ATCC #13706-B1). After complete E. coli lysis and filtering through a 0.2 micron membrane filter, the ΦX174 phage culture is ready to be used as the challenge solution.

This challenge solution is pumped through a ‘Chicago’ nebulizer using a peristaltic pump at a controlled flow rate and fixed air pressure. The constant challenge delivery forms aerosol droplets of a defined size (MPS 2.8-3.2 μm). The challenge level is adjusted to provide a consistent challenge of greater than 10⁶ plaque forming units per test sample. The aerosol droplets are generated in a glass aerosol chamber and drawn through the sample holder and into all glass impingers (AGI) in parallel. Each AGI contains 30 mL aliquots of sterile peptone water to collect the aerosol droplets. The aerosol challenge flow rate is maintained at 28.3 Lpm (1 CFM).

The challenge is delivered for a 1 minute interval and sampling through the AGIs is conducted for 2 minutes to clear the aerosol chamber. A control run (no media in the sample holder) is performed to determine the number of viable particles being generated in the challenge aerosol. Samples of barrier material are tested by placing them into the sample holder, initiating the challenge aerosol, and collecting the effluent air into AGIs as with the control. The AGI fluid is assayed by placing aliquots of each sample into tubes containing 2.5 mL of top agar and 1-2 drops of E. coli. The contents are mixed and poured over the surface of the bottom agar plates. All plates are incubated at 37° C.+/−2° C. for 12 to 24 hours.

The virus filtration efficiency, or VFE, is calculated as a percent difference between the test sample and a control run (without a test sample in place) using the following equation.
%VFE=[(plaques w/out filter−plaques w/filter)/(plaques w/out filter)]×100
Seal Integrity (Dye Immersion) Test

To demonstrate that the cap assembly of the present invention could retain liquids and their contaminants, a dye immersion test is performed. This procedure is designed to evaluate the integrity of vial closure seals.

The dye is prepared by mixing 100 mg methylene blue dye, 3 grams of Tween 80 surfactant, diluting it to 1 liter with USP purified water, and applying heat and mixing until all of the dye is dissolved. The dye is then poured into the challenge vessel.

The container vial is filled with USP purified water and sealed with the cap assembly as described. The sealed vials are then placed in the vessel containing the blue dye solution. Enough blue dye solution is added such that the sealed vials are completely submerged. The vials are kept in the solution for 24 hours. After the 24 hour period, the vials are removed and a syringe is inserted through the cap to remove several milliliters of liquid.

For determining whether samples pass or fail this test, negative controls are provided which are not exposed to the blue dye solution. Positive controls have the barrier material pierced with a 22 gauge needle and then are exposed to the blue dye solution. Methylene blue dye in pure water is visually detectable at a level of 1 μL/mL. The liquid is examined visually by comparing the test samples to control samples. The results are reported as pass/fail based on the examination. Any samples that show evidence of blue dye presence are considered failures.

Container Closure (Bacterial) Integrity Testing

This test is similar to the Seal Integrity Test described above, but measures the ability of the vial/cap assembly to resist passage of bacteria rather than a dye. The challenge media for this test was a bacteria, Brevundimonas diminuta ATCC #19146 which, when properly cultured, can pass through typical nominally rated 0.45 μm membrane filters. B. diminuta represents a severe bacterial challenge. This test is much more challenging that a BFE or VFE test because of the fact that, unlike those aerosol based challenges, the B. diminuta do not agglomerate into larger MPS particles since they are dispersed in a liquid.

A stock solution of B. diminuta is prepared by inoculating a volume of sterile soy casein digestive broth (SCDB), isolating the B. diminuta onto soybean casein digest agar (SCDA), and incubating it. The ‘stock culture’ is then used to inoculate more SCDB and is incubated to yield the ‘broth culture’. An appropriate volume of ‘broth culture’ is aseptically transferred to sterile volumes of saline lactose broth (SLB) and incubated to create the challenge suspension at titer levels of approximately 10⁷ CFU/mL.

The vial is filled with SCDB and sealed with the cap, then sterilized. The vial/cap assembly is then placed into a vessel that contains the B. diminuta challenge solution. The liquid level is sufficient to completely submerge the assembly and a rack is put in place to hold it below the surface of the challenge. The challenge liquid is stirred continuously throughout the exposure period. The assembly is kept submerged in the challenge solution for 24 hours. After removal, the outside of each assembly is rinsed off and then the assembly is placed in an incubator for 7 days at 30° C.+/−2° C. Each day, each assembly is inverted several times so that the solution comes in contact with the laminate. After 7 days, the contents of the vial/cap assembly are examined for evidence of growth of the challenge organism. Any growth is plated, identified, and quantified.

Bubble Point Test

The Bubble Point was measured on a 47 mm disc sample according to the procedures of ASTM F316-86. Isopropyl alcohol was used as the wetting fluid to fill the pores of the test specimen.

The Bubble Point is the minimum pressure of air required to displace the isopropyl alcohol from the largest pores of the test specimen and create the first continuous stream of bubbles detectable by their rise through a layer of isopropyl alcohol covering the porous media. This measurement provides an estimation of maximum pore size. Factors impacting bubble point include surface tension of the liquid, surface free energy of the membrane, and the size of the largest opening (e.g., pore). The bubble point is inversely proportional to the pore size, and thus, the higher the bubble point is, the smaller the relative pore size.

Air Flow Data—Gurley Number

The Gurley air flow test measures the time in seconds for 100 cc of air to flow through a one square inch sample when a constant pressure of 4.88 inches of water pressure is applied. The sample is measured in a Gurley Densometer (see ASTM D726-84). The sample is placed between the clamp plates. The cylinder is then dropped gently. The automatic timer (or stopwatch) is used to record the time (seconds) required for the specific volume recited above to be displaced by the cylinder. This time in seconds is the Gurley number.

Water Entry Pressure (WEP)

Water entry pressure provides a test method for water intrusion through membranes. A test sample is clamped between a pair of testing plates. The lower plate has the ability to pressurize a section of the sample with water. A piece of pH paper is placed on top of the sample between the plate on the nonpressurized side as an indicator of evidence for water entry. The sample is then pressurized in small increments, waiting 10 seconds after each pressure change until a color change in the pH paper indicates the first sign of water entry. The water pressure at breakthrough or entry is recorded as the Water Entry Pressure.

### EXAMPLE 1

A two-part, or “two-shot” cap assembly of the present invention with a geometry substantially as shown in FIGS. 1-5 was formed in the following manner.

A mold was created to provide a cap assembly with the geometry of the part described below. The mold comprised two halves, an “A” side and a moveable “B” side, and the rigid housing component was first molded from PRO-FAX 6323® polypropylene resin (Montell Polyolefins, Wilmington, Del.). The polypropylene housing had the general shape of a ring with an outside diameter of about 0.92 inches (23.4 mm), an inside diameter of about 0.74 inches (18.8 mm), and a height of about 0.29 inches (7.37 mm). Vent slots were located in the inner wall at 45°, 135°, 225°, and 315° to a depth of about 0.036 inches (0.914 mm). Crossbars measuring 0.100 inches (2.54 mm) wide and 0.080 inches (2.03 mm) thick were oriented at the top of the part at 0°, 90°, 180°, and 270° for supporting the venting media and providing a stop against which a stopper could be seated in the cap assembly. Protrusions extended from the inner wall 0.015 inches (0.381 mm) and were adapted to hold a stopper (Part No. 19500080, West Pharmaceutical Services, Inc., Lionville, Pa.), and a slated, or angled, face sloped back to the inner wall and was adapted to engage the top of a 10 ml/20 ml glass vial (Part No. 68000320, West Pharmaceutical Services, Inc.) as the cap moved to the stopper sealing position. The slated face caused the polypropylene housing to expand and the protrusions then released the stopper so that when the cap assembly was removed, the stopper remained in the vial.

The elastomeric, or in this case rubber (Santoprene®) 281-45, Advanced Elastomer Systems, Akron, Ohio), portion of the cap assembly was then molded to the bottom perimeter of the rigid housing using the two-part mold described above. The rubber portion had the same outer diameter as the rigid housing component, was about 0.08 inches (2.0 mm) thick, and had three 0.015 inches (0.381 mm) radius ribs spaced about 0.140 inches (3.56 mm) along the inside wall. The rubber portion also had a lip protruding about 0.02 inches (0.51 mm) and measuring about 0.030 inches (0.76 mm) thick around the bottom outside edge. This lip was for aiding in the automated loading process for the cap assemblies during drying operations.

The venting media to be attached to the cap assembly by heat sealing was a laminate (labeled “A”) of ePTFE bonded to a non-woven polyester material (Part Number L32242, W. L. Gore and Associates, Inc., Elkton, Md.) Material A had the following nominal laminate properties: Gurley <4.7 seconds, water entry pressure (WEP) of >16 psi, a thickness of 8-13.5 mils, and a bubble point of >5.7 psi. A round disk was first punched out from the laminate using a clicker die with 8 cavities each measuring about 0.91 inches (23.16 mm).

The cap assembly portion formed above was oriented in a nest for holding the cap during the heat sealing step. The nest was an aluminum post measuring 0.715 inches (18.2 mm) in diameter with a recess along the top into which the crossbars of the cap were fitted. Thus, with the cap on the nest, a flat area was created to allow even pressure distribution around the outer edge of the cap during heat sealing. The nest was bolted in place under a heat sealing machine consisting of an air-cylinder with a heater cartridge attached to the end during sealing. A heat sealing die consisting of aluminum with an outside diameter of about 0.91 inches (23.1 mm) and an inside diameter of about 0.81 inches (20.63 mm) was placed into the heat sealing machine and heated to 220° C.

The cap was then placed into the nest, the cut laminate was placed over the cap with the non-woven facing up, and a release material (PTFE-coated woven fiberglass, McMaster-Carr, Atlanta, Ga.) was placed over the laminate to prevent the laminate from sticking to the heat seal die. Sealing was performed with a sealing pressure of 50 psi and a dwell time of 1.25 seconds, then the release material and sealed cap assembly were removed.

Serum stoppers (West Pharmaceuticals, part number 19500080) were then inserted into the caps so that they were held tight. Vials (Part No. 68000320, West Pharmaceutical Services, Inc.) were then filled with 2.50 mL of 3% Lactose solution. After filling, the caps were placed onto the vials and then placed into the lyophilizer (along with control samples using standard lyophilization stoppers) to be tested as described in the cake appearance and solubility test. Samples of the laminate and the caps were sent to Nelson Laboratories in Salt Lake City, Utah, for VFE, Dye Immersion, and Container/Closure testing, too.

TABLE 1

| | Cake Quality | | | | |
|---|---|---|---|---|---|
| | (1 = best | | | Dye | Container/ |
| Material | 4 = worst) | Solubility | VFE* | Immersion | Closure |
| “A” | 1 | instant | 99.9999% | PASS | PASS |

*Average of 3 samples

This example demonstrates that a cap assembly as shown in FIGS. 1-5, which is a preferred construction, allows lyophilization to occur through the attached venting media and provides an isolating barrier between the contents of the vial and the external environment.

### EXAMPLE 2

A two-part, or “two-shot,” cap assembly of the present invention was formed as described in Example 1.

The venting media to be attached to the cap assembly was a laminate (labeled “B”) of an ePTFE membrane having a reference pore size of 1.0 micron (W. L. Gore and Associates, Inc., Elkton, Md.) bonded to a non-woven polyester material (Part Number B3005, HDK Industries Inc., Rogersville, Tenn.). Material B had the following measured laminate properties: Gurley 0.8 seconds, water entry pressure (WEP) of 39.4 psi, a thickness of 9 mils, and a bubble point of 11.2 psi. The laminate was cut using a hand punch measuring 0.94 inches (23.8 mm) in diameter. It was then adhered to the cap using a ring (0.94 inches (23.8 mm) O.D., 0.81 inches (20.6 mm) I.D.) of double sided silicone adhesive (Specialty Tapes, part number D650).

Serum stoppers (West Pharmaceuticals, part number 19500080) were then inserted into the caps so that they were held tight by dimple 3. Vials (Part No. 68000320, West Pharmaceutical Services, Inc.) were then filled with 2.50 mL of 3% Lactose solution. After filling, the caps were placed onto the vials and then placed into the lyophilizer (along with control samples using standard lyophilization stoppers) to be tested as described in the cake appearance and solubility test. Samples of the laminate were sent to Nelson Laboratories in Salt Lake City, Utah, for VFE testing, too.

TABLE 2

| | Cake Quality | | |
|---|---|---|---|
| Material | (1 = best 4 = worst) | Solubility | VFE* |
| “B” | 1 | instant | 99.9999% |

*Average of 3 samples

This experiment demonstrates that different venting materials in the cap assembly construction of FIGS. 1-5 allow lyophilization to occur through the attached venting media and provides an isolating barrier to airborne contaminants between the contents of the vial and the external environment.

### EXAMPLE 3

A single-part, machined cap assembly of the present invention with a geometry substantially as shown in FIG. 6 was formed in the following manner.

A polypropylene rod measuring about 1 inch (25.4 mm) in diameter was cut to a length of about 0.7 inches (17.8 mm), and the rod was machined to hollow out the interior, creating a cap with an inside diameter slightly smaller than 0.78 inches (19.8 mm), which is slightly smaller than the outside diameter of a rubber stopper (Part No. 19500080, West Pharmaceutical Services, Inc., Lionville, Pa.), which allowed the cap to grip and hold the outside surface of the stopper. Vent slots were cut at 0°, 90°, 180°, and 270° into the cap to allow for venting around the stopper, and a through-hole measuring 0.60 inches (15.24 mm) was machined into the center of the cap to provide more venting area above the stopper. The venting media was attached over this through-hole. A chamfer was then machined into the bottom of the cap to accommodate and guide a vial neck into the cap.

The venting media to be attached to the cap assembly were laminates A and B (as described in Examples 1 and 2)

Round disks were first punched out from the laminates using a clicker die with 8 cavities each measuring about 0.91 inches (23.16 mm) in diameter.

The cap assembly portion formed above was oriented in a nest for holding the cap during the heat sealing step. The nest was an aluminum post measuring 0.72 inches (18.2 mm) in diameter with a recess along the top into which the crossbars of the cap were fitted. Thus, with the cap on the nest, a flat area was created to allow even pressure distribution around the outer edge of the cap during heat sealing. The nest was bolted in place under a heat sealing machine consisting of an air-cylinder with a heater cartridge attached to the end during sealing. A heat sealing die consisting of aluminum with an outside diameter of about 0.91 inches (23.1 mm) and an inside diameter of about 0.81 inches (20.63 mm) was placed into the heat sealing machine and heated to 220° C.

The cap was then placed into the nest, the cut laminate was placed over the cap with the non-woven facing up, and a release material (PTFE-coated woven fiberglass, McMaster-Carr, Atlanta, Ga.) was placed over the laminate to prevent the laminate from sticking to the heat seal die. Sealing was performed with a sealing pressure of 50 psi and a dwell time of 1.25 seconds, then the release material and sealed cap assembly were removed.

Serum stoppers (West Pharmaceuticals, part number 19500080) were then inserted into the caps so that they were held tight by dimple 3. Vials (Part No. 6800-0320, West Pharmaceutical Services, Inc.) were then filled with 2.50 mL of 3% Lactose solution. After filling, the caps were placed onto the vials and then placed into the lyophilizer (along with control samples using standard lyophilization stoppers) to be tested as described in the cake appearance and solubility test.

TABLE 3

| | Cake Quality | |
|---|---|---|
| Material | (1 = best 4 = worst) | Solubility |
| Std lyo stopper | 1 | instant |
| “A” | 1 | instant |
| “B” | 1 | instant |

This example shows a cap assembly construction of FIG. 6 can be used for lyophilization without adversely affecting cake quality or product solubility as compared to a conventional lyophilization stopper.

### EXAMPLE 4

A two-part, or “two-shot,” cap assembly of the present invention was formed as described in Example 1.

The venting media to be attached to the cap were commercially available filtration materials as well as material B as described in Example 2.

The materials were cut using a hand punch measuring 0.94 inches (23.8 mm) in diameter. They were then adhered to the cap using a ring (0.94 inches (23.8 mm) O.D., 0.81 inches (20.6 mm) I.D.) of double sided silicone adhesive (Specialty Tapes, part number D650).

Serum stoppers (West Pharmaceuticals, part number 19500080) were then inserted into the caps so that they were held tight by dimple 3. Vials (Part No. 68000320, West Pharmaceutical Services, Inc.) were then filled with 2.50 mL of 3% Lactose solution. After filling, the caps were placed onto the vials and then placed into the lyophilizer (along with control samples using standard lyophilization stoppers) to be tested as described in the cake appearance and solubility test.

TABLE 4

| | Membrane/ | Cake Quality | |
|---|---|---|---|
| Material | barrier material | (1 = best 4 = worst) | Solubility |
| “B” | ePTFE | 1 | instant |
| 1.2 um Versapor | Acrylic copolymer | 1 | instant |
| 3.0 um Versapor | Acrylic copolymer | 1 | instant |
| Whatman HGF65 | microfiberglass | 1 | instant |
| Whatman HGF64 | microfiberglass | 1 | instant |
| 1.0 um Durapel | PVDF | 1 | instant |

This example shows a cap assembly of FIGS. 1-5 with a variety of commercially available venting materials which allows formation of cakes with satisfactory quality and solubility.

### EXAMPLE 5

A single-part, machined cap assembly of the present invention was made as described in Example 3.

The venting media to be attached to the cap were commercially available filtration materials as well as material B as described in Example 2.

The laminates were cut using a hand punch measuring 0.94 inches (23.8 mm) in diameter. They were then adhered to the cap using a ring (0.94 inches (23.8 mm) O.D., 0.81 inches (20.6 mm) I.D.) of double sided silicone adhesive (Specialty Tapes, part number D650).

Serum stoppers (West Pharmaceuticals, part number 19500080) were then inserted into the caps so that they were held tight by dimple 3. Vials (Part No. 6800-0320, West Pharmaceutical Services, Inc.) were then filled with 2.50 mL of 3% Lactose solution. After filling, the caps were placed onto the vials and then placed into the lyophilizer (along with control samples using standard lyophilization stoppers) to be tested as described in the cake appearance and solubility test.

TABLE 5

| | Membrane/ | Cake Quality | |
|---|---|---|---|
| Material | barrier material | (1 = best 4 = worst) | Solubility |
| “B” | ePTFE | 1 | instant |
| 3.0 um Versapor | Acrylic copolymer | 1 to 2+ | instant |
| Whatman HGF65 | microfiberglass | 1 | instant |
| Whatman HGF64 | microfiberglass | 2+ | instant |
| 1.0 um Durapel | PVDF | 1− to 2+ | instant |

This example demonstrates that a cap assembly as shown in FIG. 6 made with a variety of venting materials allows suitable cake quality and solubility as compared to a conventional lyophilization stopper.

1. A cap assembly comprising:
a cap having a recess for sealing to a container and a vapor path opening for vapor passage between the container and an external atmosphere;
a venting media attached to the cap and oriented in said vapor path forming a barrier isolating the container from the external atmosphere;
a stopper seated in a first position within the cap adjacent the recess, said first position allowing passage of vapor between the container and the external atmosphere;
said stopper being movable to a second position in the container to close the container and prevent the passage of vapor.

2. The cap assembly of claim 1, wherein said cap is hermetically sealed to said container.

3. The cap assembly of claim 1, wherein said cap comprises a single material.

4. The cap assembly of claim 1, wherein said cap comprises at least two components.

5. The cap assembly of claim 4, wherein said cap assembly comprises a rigid section and a conformable section.

6. The cap assembly of claim 1, wherein said venting media comprises a hydrophobic material.

7. The cap assembly of claim 1, wherein said venting media comprises expanded PTFE.

8. A cap assembly for the isolation of contents in a container comprising:
a cap having (a) a recess adapted for sealing to a container and for maintaining a stopper over the container, and (b) a vapor path opening for vapor passage between the container and an external atmosphere; and
a venting media attached to the cap and oriented in said vapor path forming a barrier isolating the container from the external atmosphere,
said cap assembly being adapted for maintaining the stopper in a first position which allows passage of vapor between said container and the external atmosphere and moving said stopper to a second position to close the container and prevent the passage of vapor.

9. The cap assembly of claim 8, wherein said cap is hermetically sealed to said container.

10. The cap assembly of claim 8, wherein said cap comprises a single material.

11. The cap assembly of claim 8, wherein said cap comprises at least two components.

12. The cap assembly of claim 11, wherein said cap assembly comprises a rigid section and a conformable section.

13. The cap assembly of claim 8, wherein said venting media comprises a hydrophobic material.

14. The cap assembly of claim 8, wherein said venting media comprises expanded PTFE.

15. A cap assembly for the isolation of contents of at least one vial located in a container, comprising
a cap having (a) a recess for sealing to the container and for maintaining at least one stopper over the at least one vial located in the container, and (b) a vapor path opening for vapor passage between the at least one vial in the container and an external atmosphere;
a venting media attached to the cap and oriented in said vapor path forming a barrier isolating the container and the at least one vial located therein from the external atmosphere;
said cap assembly being adapted for maintaining the at least one stopper in a first position which allows passage of vapor between said at least one vial and the external atmosphere and moving said at least one stopper to a second position in the at least one vial to close the vapor path and prevent the passage of vapor.

16. The cap assembly of claim 15, wherein said cap is hermetically sealed to said container.

17. The cap assembly of claim 15, wherein said cap comprises a single material.

18. The cap assembly of claim 15, wherein said cap comprises at least two components.

19. The cap assembly of claim 18, wherein said cap assembly comprises a rigid section and a conformable section.

20. The cap assembly of claim 15, wherein said venting media comprises a hydrophobic material.

21. The cap assembly of claim 15, wherein said venting media comprises expanded PTFE.

22. A method for isolating and processing contents in a container comprising:
providing a cap assembly comprising (1) a cap having (a) a recess adapted for sealing to a container and for maintaining a stopper over the container, and (b) a vapor path opening for vapor passage between the container and an external atmosphere; and (2) a venting media attached to the cap and oriented in said vapor path forming a barrier for isolating the container from the external atmosphere, said cap assembly being adapted for maintaining the stopper in a first position which allows passage of vapor between said container and the external atmosphere and moving said stopper to a second position to close the container and prevent the passage of vapor;
sealing said cap assembly to the container having therein material to be processed with the stopper oriented in the first position to allow passage of vapor between said container and the external atmosphere;
processing the material in the container; and
moving said cap assembly and said stopper to a second position to close the container and prevent the passage of vapor.

23. The method of claim 22, wherein said attaching provides a hermetic seal between said cap assembly and said container.

24. The method of claim 22, wherein said processing comprises at least one method selected from the group consisting of evaporative drying, sublimation drying, cell culturing, fumigation, mixing under controlled atmosphere and reacting under controlled atmosphere.

25. The method of claim 22, wherein said processing comprises freeze-drying.

26. The method of claim 22, wherein said stopper is held within said cap assembly.
